(19) United States
(12) Patent Application Publication
(10) Pub. No.: US 2019/0344718 A1
(43) Pub. Date: Nov. 14, 2019

(54) DISPLAY SYSTEM FOR A VEHICLE

(71) Applicant: VISTEON GLOBAL TECHNOLOGIES, INC., Van Buren Township, MI (US)

(72) Inventors: Brian John Hayden, Royal Oak, MI (US); Paul Fredrick Luther Weindorf, Novi, MI (US); Matthew T. Frantz, Van Buren Township, MI (US)

(73) Assignee: VISTEON GLOBAL TECHNOLOGIES, INC., Van Buren Township, MI (US)

(21) Appl. No.: 16/408,229

(22) Filed: May 9, 2019

Related U.S. Application Data
(60) Provisional application No. 62/669,030, filed on May 9, 2018.

(51) Int. Cl. B60R 1/12; G02B 5/30; G02B 1/11

(52) U.S. Cl. CPC B60R 1/12; G02B 5/3025; B60R 1/04; B60R 2001/1215; G02B 1/11

(57) ABSTRACT

A display system includes a display device disposed in a housing. A mirror element is disposed in the housing proximate to and cooperating with the display device. A lens is disposed proximate to and in a coplanar arrangement with the mirror element. The display device is positioned on an angle in a non-planar arrangement with the mirror element and the lens to reduce matrix scatter in the display device.

### CROSS REFERENCE TO RELATED APPLICATIONS

This application claims the benefit of U.S. Provisional Patent Application No. 62/669,030, filed on May 9, 2018, and entitled “E-MIRROR MATRIX SCATTER COMPENSATION METHOD,” which is incorporated by reference in its entirety in this disclosure.

### TECHNICAL FIELD

Embodiments described herein generally relate to a display system for a vehicle for displaying an image.

### BACKGROUND

Electronic displays are provided in many contexts to electronically render digital information to a viewer. The electronic displays receive information and render the information through lighted cells in patterns that reflect the texts and pictures employed to convey the information. In the vehicular space, electronic-mirrors or e-mirrors have been developed to convey information in a vehicle. An electronic mirror is a display device that allows content to be viewable in the reflective state and to be a display device in the display state.

The use of electronic mirrors is becoming more prevalent because a more inclusive image can be presented to the driver with no or less blind spots due to vehicle design. However, there is a need to have a traditional reflection-based mirror as a backup if the cameras or other image processing electronics become non-operational. Although not required, it is also desirable to have the features of automatic luminance control when in the display mode and auto dimming when in the traditional mirror mode.

FIG. 1 illustrates an electronic mirror or e-mirror 10 according to one prior art implementation. A rear cover 12 serves as a housing 14 for the mirror 10. The housing 14 cooperates with a front bezel 16 having an opening 18 sized to receive a lens 20. The lens 20 is adjusted between a reflective state and a display state by a toggle switch 22 to allow the electronic mirror to be oriented towards a headliner of a vehicle during a display mode.

FIG. 2 illustrates a side-view of the prior art electronic mirror 10 as described in FIG. 1. As shown, a display 24 cooperates with a mirror element 26, which is disposed proximate an electrochromic absorber 28. Conventionally, electrochromic materials have been used for the electrochromic absorber 28 of the electrochromic mirror element. Illumination 30 from a source element, such as headlights from a vehicle rearward of the mirror, may be projected through the electrochromic absorber 28 toward the mirror element 26.

The mirror element 26 may reflect about 50% of the light 32 and allow 50% transmission of content from the display 24 to be seen. The mirror element 26 may introduce a phenomenon known as ghost images, due to the mirror element 26 allowing 50% transmission of light 34 from display 24 (to allow content from the display to be seen), while also allowing the electronic mirror to maintain reflective properties.

Thus, because of the ghost image phenomenon shown in FIG. 2, the user sees the reflected image of the headliner or the roof overlaid on the display video image. Since the video image and reflected image are at different focal planes, the user may experience eye fatigue and may have difficulties focusing on the display image. Even with directing the mirror towards the headliner, problems occur when the reflected image includes a sunroof since the electrochromic optical element transmission cannot be reduced in order to maximize display transmission.

### SUMMARY

A display system includes a display device disposed in a housing. A mirror element is disposed in the housing proximate to and cooperating with the display device. A lens is disposed proximate to and in a coplanar arrangement with the mirror element. The display device is positioned on an angle in a non-planar arrangement with the mirror element and the lens to reduce matrix scatter in the display device.

The mirror element of the display system may include a first reflective polarizer layer, a rotator cell layer cooperating with the first reflective polarizer layer, a second reflective polarizer layer cooperating with the rotator cell and disposed opposite the first reflective polarizer layer, and a switchable polarizer layer cooperating with the second reflective polarizer layer. The rotator cell layer may include a liquid crystal layer which rotates polarized light by 90 degrees.

The display device may include a backlight and a display element configured to present content. The backlight sources light to generate an image on the display element. The lens is disposed adjacent the switchable polarizer layer and includes an antireflection layer to reduce reflection.

The display system may include an air gap layer introduced between the display device and the mirror element. The air gap layer may be introduced between the display element of the display device and the first reflective polarizer layer of the mirror element.

The display system may include a first antireflective layer cooperating with the display element of the backlit display on a surface opposing the air gap layer and a second antireflective layer cooperating with the first reflective polarizer layer on a surface opposing the air gap layer. The first antireflective layer on the backlit display and the second antireflective layer on the first reflective polarizer layer may cooperate with the air gap layer to reduce reflection.

In one or more embodiments of the disclosure, an electronic mirror may include a housing, a display device disposed in the housing and a mirror element disposed in the housing proximate to and cooperating with the display device. The mirror element may include a first reflective polarizer layer, a rotator cell layer cooperating with the first reflective polarizer layer, a second reflective polarizer layer cooperating with the rotator cell and disposed opposite the first reflective polarizer layer, and a switchable polarizer layer cooperating with the second reflective polarizer layer.

An air gap layer is introduced between the display device and the mirror element. A lens is disposed proximate to and in a coplanar arrangement with the mirror element. The display device is positioned on an angle in a non-planar arrangement relative to the mirror element and the lens to reduce matrix scatter in the display device.

In another one or more embodiments of the disclosure, an electronic mirror may include a housing and a display device disposed in the housing. The display device may include a backlight and a display element configured to present content. The backlight sources light to generate an image on the display element.

A mirror element is disposed in the housing proximate to and cooperating with the display device. The mirror element includes a first reflective polarizer layer, a rotator cell layer cooperating with the first reflective polarizer layer, a second reflective polarizer layer cooperating with the rotator cell and disposed opposite the first reflective polarizer layer and a switchable polarizer layer cooperating with the second reflective polarizer layer. An air gap layer is introduced between the display device and the mirror element. The air gap layer is introduced between the display element of the display device and the first reflective polarizer layer of the mirror element.

A first antireflective layer cooperates with the display element of the backlit display on a surface opposing the air gap layer. A second antireflective layer cooperates with the first reflective polarizer layer on a surface opposing the air gap layer. A lens is disposed proximate to and in a coplanar arrangement with the mirror element. The display device is positioned on an angle a non-planar arrangement relative to the mirror element and the lens to reduce matrix scatter in the display device.

The above features and advantages and other features and advantages of the present disclosure are readily apparent from the following detailed description of the best modes for carrying out the disclosure when taken in connection with the accompanying drawings.

### BRIEF DESCRIPTION OF THE DRAWINGS

FIG. 1 is a perspective view of a prior art electronic mirror.

FIG. 2 is an exploded side view of the prior art electronic mirror of FIG. 1.

FIG. 3 is an exploded perspective view of a display system in accordance with one or more embodiments of the disclosure.

FIG. 4 is a schematic diagram illustrating an exemplary implementation of the display system including a display device and mirror element in accordance with one or more embodiments of the disclosure.

FIG. 5 is a fragmentary side plan view illustrating at least one exemplary implementation of the display system including a display device and mirror element in accordance with one or more embodiments of the disclosure.

FIG. 6 is a fragmentary side plan view illustrating of another of an exemplary implementation of the display system including a display device and mirror element in accordance with one or more embodiments of the disclosure.

FIG. 7 is a schematic diagram of the display system illustrating alignment of one or more components of the display system in accordance with one or more embodiments of the disclosure.

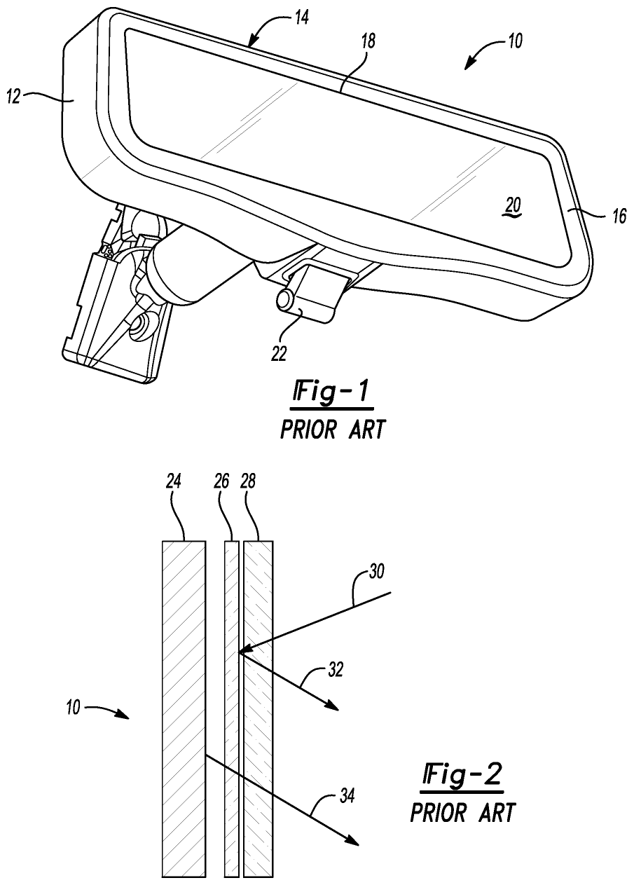

The present disclosure may have various modifications and alternative forms, and some representative embodiments are shown by way of example in the drawings and will be described in detail herein. Novel aspects of this disclosure are not limited to the forms illustrated in the above-enumerated drawings. Rather, the disclosure is to cover modifications, equivalents, and combinations falling within the scope of the disclosure as encompassed by the appended claims.

### DETAILED DESCRIPTION

Those having ordinary skill in the art will recognize that terms such as “above,” “below,” “upward,” “downward,” “top,” “bottom,” “forward,” “rearward,” etc., are used descriptively for the figures, and do not represent limitations on the scope of the disclosure, as defined by the appended claims. Furthermore, the teachings may be described herein in terms of functional and/or logical block components and/or various processing steps. It should be realized that such block components may be comprised of any number of hardware, software, and/or firmware components configured to perform the specified functions.

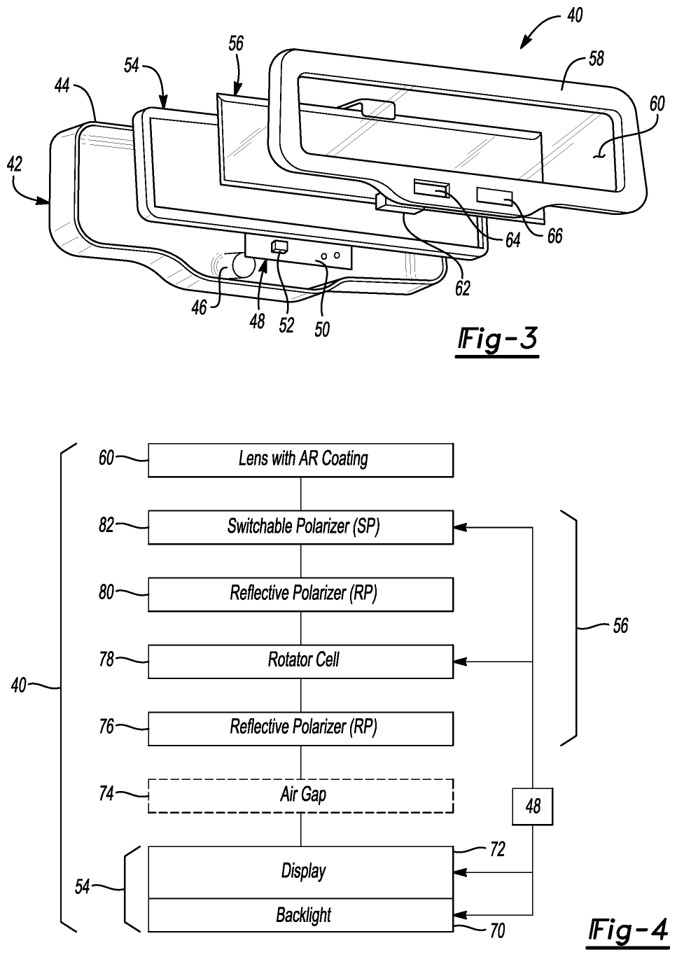

Referring to the Figures, wherein like numerals indicate like parts throughout the several views, FIG. 3 illustrates a display system 40. The display system 40 may be a display system in the form of an electronic mirror or e-mirror such as a rear-view mirror, a visor mirror, an exterior side mirror or another type of vehicle display and/or mirror. Alternatively, the display system 40 in accordance with one or more embodiments of the disclosure may comprise another type of display system, such as an instrument cluster, heads-up display or the like.

The display system 40 shown in FIG. 3 is an electronic mirror 42 for use in the interior of a motor vehicle. The electronic mirror 42 may be positioned adjacent a forward portion of a vehicle interior (not shown). For example, in one or more embodiments, the electronic mirror 42 of the display system 40 may additionally be positioned on or proximate a windshield or windscreen (not shown) of the vehicle. It is understood that the electronic mirror 42 or other form of display system could be implemented in other regions of the vehicle, such as dashboard, console or other interior space and positioned on or proximate a structural portion of the vehicle, including, but not limited to, a vehicle panel or headliner, vehicle roof surface or vehicle frame to accomplish the objectives of this disclosure.

The electronic mirror 42 includes a housing 44 that may cooperate with one or more positioning elements 46 to mount the electronic mirror 42 to a portion of the vehicle interior (not shown). The housing 44 of the electronic mirror 42 may receive and support one or more components of the electronic mirror 42. The one or more components of the electronic mirror 42 of the display system 40 may include a controller 48 incorporating components, such as printed circuit board (PCB) 50 and one more input devices 52 mounted thereon in electrical communication with the PCB 50.

The controller 48 may include one or more processors, each of which may be embodied as a separate processor, an application specific integrated circuit (ASIC), or a dedicated electronic control unit. The controller 48 may be any sort of electronic processor (implemented in hardware, software, or a combination of both) installed in a vehicle to allow the various electrical subsystems to communicate with each other. The controller 48 also includes tangible, non-transitory memory (M), e.g., read only memory in the form of optical, magnetic, and/or flash memory.

Computer-readable and executable instructions embodying the present method may be stored in memory (M) and executed as set forth herein. The executable instructions may be a series of instructions employed to run applications on the controller 48 (either in the foreground or background) and allow either automated control of the vehicular subsystems or direct control through engagement of an occupant of the vehicle in any of the provided human machine interface (MU) techniques, such as the input device 52.

The input device 52 may include any type of device that provides input the controller 48, such as touch-activated instructions inputted from a touch screen, voice-activated inputs inputted from an audio device, manual inputs, such as a mechanical or electrical stimulus, external inputs from an external device, or the like, that causes the electronic mirror 42 to adjust between one or more display modes, such as from a reflective state or a mirror mode to a display state or video mode, through the adjustment of one or more components of the display system 40.

The electronic mirror 42 of the display system 40 includes a projection device or display device 54 disposed within the housing 44. The display device 54 may be any sort of device capable of generating or configured to generate an image or digitally render information to present to a viewer for display on a projection surface. For example, in one or more embodiments, the display device 54 may include a backlight 70 and a projection surface or display element 72 as shown in FIG. 4.

An optical viewing layer or mirror element 56 cooperates with the display device 54. The mirror element 56 may be disposed proximate to and adjustable relative to the display device 54 and includes a semi-transparent reflective surface. The semi-transparent reflective surface of the mirror element may be one of a semi-transparent mirror or a semi-transparent reflective polarizing layer. For example, the mirror element 56 may include a partially reflective surface that provides a mirror surface to reflect images from the rear of the vehicle when the display device 54 is inactive. The mirror element 56 may additionally incorporate a partially transparent surface that allows information or content generated on the display device 54 to be viewed by a viewer through the mirror element 56.

The housing 44 of the electronic mirror 42 may further include a cover surface or bezel 58 at least partially enclosing one or more of the controller 48, display device 54 and mirror element 56 of the electronic mirror 42. Bezel 58 may be configured to face a viewer of the display system 40 and is sized to at least partially receive and cooperate with a lens 60. The lens 60 is disposed proximate the mirror element 56 and is generally transparent to allow images generated by the display device 54 or images reflected by the mirror element 56 to be viewed by the viewer. It is also understood that the lens 60 may be incorporated as part of the mirror element 56. The mirror element 56 is in a generally parallel, coplanar arrangement with the lens 60.

A button or switch 62 cooperates with the mirror element 56 and extends through an aperture 64 in the bezel 58. In one or more of the embodiments, the switch 62 additionally may cooperate with the input device 52 to adjust the one or more components of the display system 40, such as adjustment of the mirror element 56 from the first position to the at least one second position. At least one sensor 66 may also be provided in the bezel 58. The at least one sensor 66 may include a rear facing sensor, shown as reference numeral 66 in the Figures, and may further include a front facing sensor (not shown). The at least one sensor 66 may record ambient lighting conditions and cooperate with the controller 48 to adjust the luminance settings of the display device 54 or the mirror reflectance of the mirror element 56.

Referring now to FIGS. 4-6, a diagram of the display system 40 is illustrated. The display system includes a display device 54 having at least a backlight 70 and a projection surface or display element 72 configured to present content on the display element 72. The backlight 70 sources light to the display element 72. The display device 54 may be a light emitting display, such as an organic light emitting diode (OLED) display, liquid crystal display (LCD) a thin-film transistor (TFT) display or other suitable display for the presentation of information. The backlight 70 sources light to the projection surface or display element 72, which, using technology such as liquid crystal cell-based technology, determines a pattern to illuminate and make viewable to the viewer of the display device 54.

As is best shown in FIG. 4, the mirror element 56 may include a first reflective polarizer layer 76. A first liquid crystal layer or rotator cell layer 78 may be disposed adjacent and overlap the first reflective polarizer layer 76. The rotator cell layer 78 may include a liquid crystal layer such as a Thin Film Transistor (TFT) liquid crystal display (LCD), otherwise referred to as the TFT display layer. Alternatively, the rotator cell layer 78 may be formed as another form of liquid crystal cell device configuration, such as multiplexed film compensated super twist nematic (FSTN), twisted nematic (TN), in-plane switching (IPS), multi-domain vertical alignment (MVA) or another type of liquid crystal display mode that causes light polarization rotation. Alternatively, the rotator cell layer 78 may be formed as an electronically controlled wave plate.

The liquid crystal layer of the rotator cell layer 78 rotates polarized light by 90 degrees. In general, propagating light waves generate an electric field. The electric field oscillates in a direction that is perpendicular/orthogonal to the light wave's direction of propagation. Light is unpolarized when the fluctuation of the electric field direction is random. Light may be described as polarized when fluctuation of the electric field is highly structured, with laser beams being a common example of highly polarized light and sunlight or diffuse overhead incandescent lighting being examples of unpolarized light.

The control voltage source can be applied so that the crystals of the rotator cell layer 78 may either be orthogonal to the display device 54 or perpendicular to the display device 54. When the crystals are parallel to the display device 54, the polarization of light is rotated. The controller 48 may either apply a drive voltage to turn on the rotator layer or remove the drive voltage to turn off the rotator cell layer 78. The controller may further apply a pulse width modulated (PWM) voltage to the display device 54 described herein.

A second reflective polarizer layer 80 may be disposed adjacent and overlap the rotator cell layer 78 and disposed on an opposing portion or side of the rotator cell layer 78 from the first reflective polarizer layer 76. Each of the first reflective polarizer layer 76 and the second reflective polarizer 80 may be formed as a reflective polarizer film. Two or more classes of reflective polarizer materials may be used for the first and second reflective polarizers 76, 80, including, but not limited to, 3M™ Reflective Polarizer Mirror (RPM) and 3M™ Windshield Combiner Film (WCF), both available from THE 3M COMPANY, with headquarters located in Maplewood, Minn. Other reflective polarizer materials having similar properties such as wire grid polarizers may be used to form the first and second reflective polarizer layers 76, 80 in other embodiments.

A switchable polarizer layer 82 may be disposed adjacent and overlap the second reflective polarizer layer 80. The switchable polarizer layer 82 may be electrically coupled to a control voltage source (not shown) and adjustable in response to one or more control signals from the controller 48. The switchable polarizer layer 82 is configured to switch polarization state between a non-polarized state and a polarized state in response to an applied voltage. It is understood that the switchable polarizing layer 82 may vary in type or configuration.

In one or more embodiments of the disclosure, the display device 54, the rotator cell layer 78 and the switchable polarizer layer 82 may be electrically coupled to a controllable voltage source and the controller 48. In response to activation of the display device 54 by the controller 48, the controllable voltage source may be configured to apply a voltage to adjust the rotator cell layer 78 and the switchable polarizer layer 82 to adjust the mirror element between a “mirror mode” and a “video mode” or a display mode.

The lens 60 may be disposed adjacent and overlap the switchable polarizer layer 82. The lens 60 may include an antireflection (AR) layer 84 to reduce the reflection rate by approximately 4%. Between the display device 54 and the mirror element 56, the use of AR layer 84 reduces the amount of reflection by 2% for each air to glass interface because only half of the light can go through the mirror element 56 due to the reflective polarization films. In one or more embodiments, when index matching the glass to air or front display polarizer to air with AR coating or motheye film, light is minimally reflected at these interfaces to a reflectance of less than 0.4% reflection.

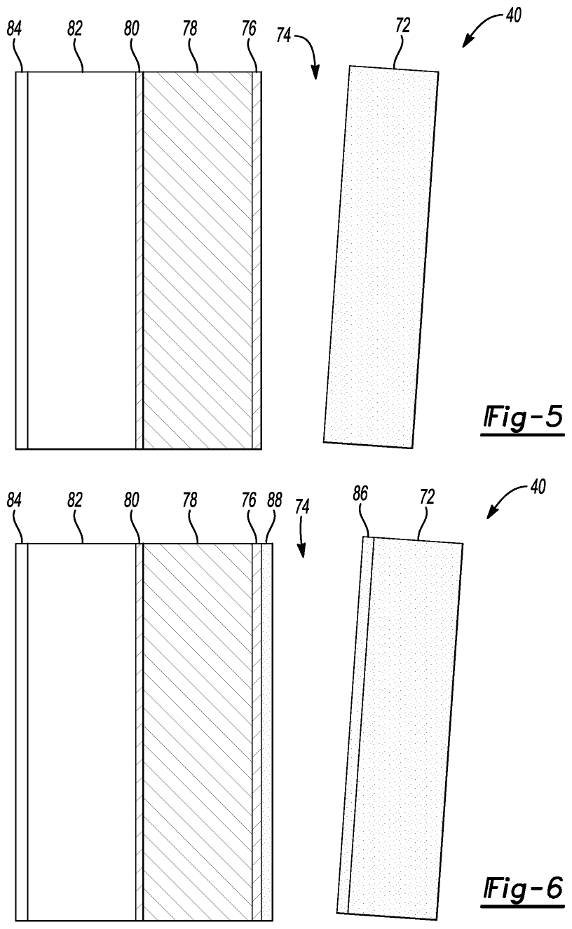

In one or more embodiments of the disclosure, at least one air gap layer 74 is provided between the display device 54 and the first reflective polarizer layer 76 of the mirror element 56. The at least one air gap layer 74, or index matching layer, may overlap the display device 54 and/or the mirror element 56. FIGS. 5 and 6 illustrate variations for implementation of the at least one air gap layer 74 in the display system 40. Referring to FIG. 5, the at least one air gap layer 74 introduced in between the display element 72 of the display device 54 and the first reflective polarizer layer 76 of the mirror element 56.

Referring to one or more alternative embodiments in FIG. 6, the display system 40 may further include a first anti-reflective layer 86 that may be disposed proximate to and/or abut the display element 72 and a second anti-reflective layer 88 that may be disposed proximate to and/or abut the first reflective polarizer layer 76. Introduction of the first and second anti-reflective layers 86, 88 in combination with the air gap 74 reduces reflection as compared to the configuration illustrated in FIG. 5 wherein only an air gap 74 is introduced between the display element 72 and first reflective polarizer layer 76 of the mirror element. In one or more embodiments, the first anti-reflective layer and/or the second anti-reflective layer 88 may use an AR coating or motheye film to reduce the reduce the reflection with the air interface from 4% reflection to a reflectance of less than 0.2% reflection.

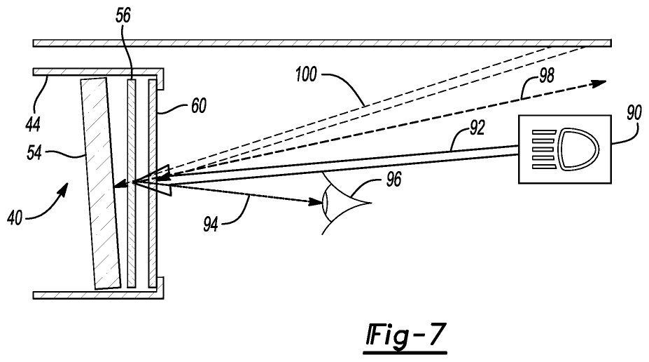

Referring now to FIG. 7, a solution to eliminate matrix scatter from the display device 54 from the display system 40 is described in greater detail. Matrix scatter is described as a star pattern emanating from the specular distinct image, and often there will be different colors visible because of the diffraction pattern generating matrix scatter. Therefore, reflected matrix scatter causes the light component, which is passed through a mirror element 56, to not be effectively absorbed as a beam stop by a display device 54, which is, in turn, reflected towards the viewer. Since the matrix scatter is caused by structures (e.g. row and column lines) internal to the display device 54, external anti-reflection counter measures are not be effective for this reflection component.

An additional challenge with the display system 40 is that when a “video mode” or display mode is enabled, and the mirror element 56 reflection is reduced to the minimum level, a reflection component may exist since the optical mirror elements introduce imperfections in reflectance. This reflection component or reflectance may range from about 6% to 12% depending on the optical construction. This reflection component may cause a reflection of an image of car headlights that will not be aligned to the camera image and therefore will confuse the viewer (i.e. there will be two sets of car headlights for every car). Therefore, if the reflection rate is too high, the entire display system 40 consisting of the tilted display device 54 and the mirror element 56 may need to be mechanically rotated by about 4 degrees in the display mode such that the user sees the reflection of the headliner of the vehicle 10 on the mirror element 56.

FIG. 7 illustrates one or more embodiments to compensate for matrix scatter, namely, to tilt or position the display device 54 on an angle in a non-planar arrangement relative to the mirror element 56 and lens 60 to reduce matrix scatter. In one non-limiting example, the display device 54 may be tilted or positioned at an angle of about 4° (4 degrees) relative to the mirror element 56. For example, the top portion of the display device 54 may be tilted away or positioned an angle of about 4° (4 degrees) from the mirror element 56 while the bottom portion of the display device may be tilted toward the mirror element 56. Alternatively, the top portion of the display device 54 may be tilted toward or positioned an angle of about 4° (4 degrees) relative to the mirror element 56 while the bottom portion of the display device 54 may be tilted away from the mirror element 56.

In the “video mode” or the display mode illustrated in FIG. 7, content on the display device 54 may be presented or viewed through the mirror element 56 by the viewer 96 as represented by arrow and reference numeral 94. The semi-transparent reflective surface of the mirror element 56 may be one of a semi-transparent mirror or a semi-transparent reflective polarizing layer. The viewer 96 will not see the illumination 90 from the source 92 in the mirror element 56, thereby ensuring no ghost images will be visible.

Due to the angular positioning of the display device 54 relative to the mirror element 56 and lens 60, none of the illumination 90 from the headlight or light source 92 is in the field of view, as represented by arrow and reference numeral 98, for the viewer 96. The viewer 96 only sees only the display and the small amount of reflection from the headliner, represented by reference numeral and arrow 100. It is understood that headliners generally are formed with a non-reflective covering or material, which reduces the deleterious effects associated with reflection or glare from this surface and eliminates the matrix scatter component.

Additionally, since the viewer 96 does not see any of the headlight reflection components, an anti-reflective film (AR) may no longer be needed on the front or back of the lens 60. Alternatively, the display system 40 may be adjusted so that the viewer 96 sees the reflection of the headliner 100 on the mirror element 56. In one non-limiting example, the display system 40 may be adjusted such that the mirror element 56 may be rotated upward by about 4 degrees and the display device may be rotated upward by about 8 degrees as the display device 54 is tilted about 4 degrees relative to the mirror element 56.

The detailed description and the drawings or figures are supportive and descriptive of the disclosure, but the scope of the disclosure is defined solely by the claims. While some of the best modes and other embodiments for carrying out the claimed teachings have been described in detail, various alternative designs and embodiments exist for practicing the disclosure defined in the appended claims.

1. A display system comprising:
a housing;
a display device disposed in the housing;
a mirror element disposed in the housing proximate the display device; and
a lens disposed proximate to and in a coplanar arrangement with the mirror element,
wherein the display device is positioned on an angle in a non-planar arrangement relative to the mirror element and the lens to reduce matrix scatter in the display device.

2. The display system of claim 1 wherein the mirror element includes:
a first reflective polarizer layer;
a rotator cell layer cooperating with the first reflective polarizer layer;
a second reflective polarizer layer cooperating with the rotator cell layer and disposed opposite the first reflective polarizer layer; and
a switchable polarizer layer cooperating with the second reflective polarizer layer.

3. The display system of claim 2 wherein the rotator cell layer further comprises a liquid crystal layer, wherein the liquid crystal layer of the rotator cell layer rotates polarized light by 90 degrees.

4. The display system of claim 1 wherein the display device further comprises a backlight and a display element configured to present content, wherein the backlight sources light to generate an image on the display element.

5. The display system of claim 1 wherein the lens is disposed adjacent the switchable polarizer layer and includes an antireflection layer to reduce reflection.

6. The display system of claim 1 further comprising an air gap layer is introduced between the display device and the mirror element.

7. The display system of claim 6 wherein the air gap layer is introduced between the display element of the display device and a first reflective polarizer layer of the mirror element.

8. The display system of claim 7 further comprising a first antireflective layer cooperating with the display element of the display device on a surface opposing the air gap layer and a second antireflective layer cooperating with the first reflective polarizer layer on a surface opposing the air gap layer, wherein the first antireflective layer and the second antireflective layer cooperate with the air gap layer to reduce reflection.

9. An electronic mirror comprising:
a housing;
a display device disposed in the housing;
a mirror element disposed in the housing proximate the display device, wherein the mirror element includes:
a first reflective polarizer layer,
a rotator cell layer cooperating with the first reflective polarizer layer,
a second reflective polarizer layer cooperating with the rotator cell layer and disposed opposite the first reflective polarizer layer, and
a switchable polarizer layer cooperating with the second reflective polarizer layer;
an air gap layer introduced between the display device and the mirror element; and
a lens disposed proximate to and in a coplanar arrangement with the mirror element,
wherein the display device is positioned on an angle in a non-planar arrangement relative to the mirror element and the lens to reduce matrix scatter in the display device.

10. The electronic mirror of claim 9 wherein the rotator cell layer further comprises a liquid crystal layer, wherein the liquid crystal layer of the rotator cell layer rotates polarized light by 90 degrees.

11. The electronic mirror of claim 9 wherein the display device further comprises a backlight and a display element configured to present content, wherein the backlight sources light to generate an image on the display element.

12. The electronic mirror of claim 11 wherein the air gap layer is introduced between the display element of the display device and the first reflective polarizer layer of the mirror element.

13. The electronic mirror of claim 12 further comprising a first antireflective layer cooperating with the display element of the display device on a surface opposing the air gap layer and a second antireflective layer cooperating with the first reflective polarizer layer on a surface opposing the air gap layer, wherein the first antireflective layer and the second antireflective layer cooperate with the air gap layer to reduce reflection.

14. The electronic mirror of claim 9 wherein the lens is disposed adjacent the switchable polarizer layer and includes an antireflection layer to reduce reflection.

15. An electronic mirror comprising:
a housing;
a display device disposed in the housing, wherein the display device further comprises a backlight and a display element configured to present content, wherein the backlight sources light to generate an image on the display element;
a mirror element disposed in the housing proximate the display device, wherein the mirror element includes:
a first reflective polarizer layer,
a rotator cell layer cooperating with the first reflective polarizer layer,
a second reflective polarizer layer cooperating with the rotator cell layer and disposed opposite the first reflective polarizer layer, and
a switchable polarizer layer cooperating with the second reflective polarizer layer;
an air gap layer introduced between the display device and the mirror element, wherein the air gap layer is introduced between the display element of the display device and the first reflective polarizer layer of the mirror element;
a first antireflective layer cooperating with the display element of the display device on a surface opposing the air gap layer;
a second antireflective layer cooperating with the first reflective polarizer layer on a surface opposing the air gap layer; and
a lens disposed proximate to and in a coplanar arrangement with the mirror element,
wherein the display device is positioned on an angle in a non-planar arrangement relative to the mirror element and the lens to reduce matrix scatter in the display device.

16. The electronic mirror of claim 15 wherein the rotator cell layer further comprises a liquid crystal layer, wherein the liquid crystal layer rotates polarized light by 90 degrees.

17. The electronic mirror of claim 16 wherein the first antireflective layer on the display element and the second antireflective layer on the first reflective polarizer layer cooperate with the air gap layer to reduce reflection.

18. The electronic mirror of claim 15 wherein the lens is disposed adjacent the switchable polarizer layer and includes an antireflection layer to reduce reflection.
